(19) United States
(12) Patent Application Publication
(10) Pub. No.: US 2025/0377862 A1
(43) Pub. Date: Dec. 11, 2025

(54) SYSTEM AND METHOD FOR SOFTWARE MONITORING AND MAINTENANCE

(71) Applicant: Morgan Stanley Services Group Inc., New York, NY (US)

(72) Inventors: Ernest FASULO, Plantation, FL (US); John CILLUFFO, Midland Park, NJ (US)

(73) Assignee: Morgan Stanley Services Group Inc., New York, NY (US)

(21) Appl. No.: 18/739,582

(22) Filed: Jun. 11, 2024

(51) Int. Cl. G06F 8/30

(52) U.S. Cl. CPC G06F 8/30

(57) ABSTRACT

A system and method may manage a computer by executing, by a job scheduler on the computer, a framework script written in a scripting language which discovers installed sub-task scripts and executes discovered sub-task scripts. Sub-task scripts may be stored in directories corresponding to accounts in which a sub-task script is to be run. Sub-task scripts may perform maintenance or monitoring tasks. A system and method may assign resource access or permissions for a set of computers, by, for each computer of a set of computers, determining the organizational unit and sub-organizational unit of the computer; and for each computer of the set of computers assigning the computer to a security group, based on the organizational unit and sub-organizational unit of the computer. For each computer, the security group the computer is assigned to may be associated with permissions enforced for each computer in the group.

### FIELD OF THE INVENTION

The present invention relates generally to management of, configuration of, and data collection from large numbers of computers, for example by information technology (IT) processes in an organization.

### BACKGROUND OF THE INVENTION

In an enterprise environment many (e.g. tens of thousands) of computers such as workstations, PCs, desktop computers, laptops, servers, routers, etc., are managed and monitored, For example, computers may have software installed, configurations changed, maintenance performed, backups to remote systems performed, and data on computer performance sent to centralized systems. Performing this work often requires individual attention to be paid by IT professionals to each computer, for example because performing management or data gathering tasks may require the knowledge and maintenance of passwords for each computer, or logging in to each computer. This takes up a large amount of time by IT professionals, and may pose security risks, which are inherent in any password-based system. An automated solution, not requiring large amounts of time spent by IT professionals, and not being based on passwords, is desirable.

Such management and monitoring may rely on computers being managed having access to remote resources, such as remote file systems. Administering permissions granting such access may also require individual attention to be paid by IT professionals to each computer, and the use and maintenance of passwords. An automated solution for granting such access, not requiring large amounts of time spent by IT professionals, and not being based on passwords, is desirable.

### SUMMARY OF THE INVENTION

A system and method may control or manage a computer by executing, by a job scheduler process on the computer, a framework script, the framework script written in a scripting language; discovering by the framework script sub-task scripts installed on the computer, each sub-task script written in the scripting language; and executing, by the framework script, each discovered sub-task script. Each sub-task script may be stored in a directory corresponding to an account in which the sub-task script is to be run. Sub-task scripts may perform maintenance or monitoring tasks such as defragmenting, determining computer software, OS, or hardware parameters and transmitting them to a remote computer; profile maintenance; backups, etc.

A method for assigning permissions for a set of computers, may include, at a first computer, for each computer of a set of computers, determining the organizational unit and sub-organizational unit of the computer; and for each computer of the set of computers assigning the computer to a security group, based on the organizational unit and sub-organizational unit of the computer; for each computer, the security group the computer is assigned to may be associated with permissions enforced for each computer in the group. Such permissions may, for example, entitle a computer to file system resources. The group may be or correspond to a Microsoft Active Directory security group, but may be another type of group, using another permissioning system.

### BRIEF DESCRIPTION OF THE DRAWINGS

Non-limiting examples of embodiments of the disclosure are described below with reference to figures listed below. The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings.

FIG. 1 depicts a system for managing computer systems according to embodiments of the invention.

FIG. 2 depicts a flowchart of a process for controlling a computer according to some embodiments of the invention.

FIG. 3 depicts the organization of a set of computers, each associated with a computer name, ID or hostname, and their relationship to Active Directory organizational units, according to some embodiments.

FIG. 4 depicts a flowchart of a process for assigning permissions for a set of computers according to some embodiments of the invention.

FIG. 5 shows a high-level block diagram of an exemplary computing device according to some embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Embodiments may operate in an enterprise environment where many (e.g. tens of thousands) of computers (e.g. “target computers”), such as workstations, PCs, desktop computers, laptops, servers, routers, etc., are to be managed and monitored, in part by having software installed on them. For example, monitoring software may gather statistics regarding the operation of the target computer, and management or maintenance software may defragment a local disk drive, back up data, monitor for malware or viruses, etc. Gathered statistics may include disk drive or storage statistics (e.g. free space; free space below or above a threshold). Self healing may include a script reacting to a statistic, such as taking action if a statistic is above or below a threshold, For example, a script may determine free disk space, and delete temporary files if the free disk space is below a threshold. Such software is in the prior art burdensome to install and maintain, across thousands of target computers,

An embodiment may use two tasks to schedule and control monitoring, maintenance and updating of target computers. (While two tasks or processes are used as an example, embodiments may divide responsibility into other numbers of processes.) Prior art systems may rely on job or task scheduler processes such as a Windows OS built-in Task Scheduler, or the Linux chron jobs system, to perform such monitoring, maintenance and updating tasks, which may overload job scheduler processes and create conflicts, and which may be more difficult to update from a central (e.g. IT) process. Instead, embodiments of the invention may create a separate process (e.g. a framework script) that manages tasks, where this separate process may itself be managed by a job scheduler.

Embodiments may rely on two different script processes, e.g. a Task 1 (e.g. a framework or main script), which may execute or loop according to a schedule (e.g., executed according to a Task Scheduler or job scheduler), and which may execute one or more sub-scripts or sub-tasks (e.g. Task 2 scripts, which may be termed SCM (Self-Contained Modules) files) which may perform monitoring, maintenance and updating tasks. Each script may be written in a scripting language or include scripting language code, such as in the PowerShell framework, and may be a text and editable document (e.g. using a notepad application), but other scripting systems may be used, and in other embodiments the processes need not be scripts. A Task 1 framework script may execute each sub-scripts in its own work space or “bubble” which can be stopped or killed (e.g. “popped”) to control the sub-scripts. Scripts used with embodiments of the present invention may be editable text, may have primitives being elementary tasks and application programming interface (API) calls, and may be interpreted at runtime rather than compiled and run as executable (e.g. .exe) programs.

Each Task 2 sub-script may include in a header information such as how the Task 2 should be scheduled, and code or script language that performs actions. A Task 1 script may include code performing query and self-heal if needed; a Task 1 may determine if it is using too many resources, and if so, quit: in an embodiment a Task Manager or other process may start a Task 1 script periodically (e.g. every five minutes) if none is executing. A Task 1 script may determine which Task 2 scripts should be executed, and execute them, periodically, e.g. every minute, or each minute after the process of executing Task 2 scripts takes place. Embodiments may improve prior art system management by allowing easy insertion of tasks (e.g. by creation of directories and files in directories) as opposed to using a Task Manager, which involves burdens when altering tasks to be scheduled. Previous technology may include the disadvantage of requiring dedicated service accounts or programmatically generated non-human accounts; embodiments of the present invention may improve computer monitoring technology by using preexisting accounts.

Allowing for a Task 1 script to schedule and run Task 2 scripts, which perform monitoring, maintenance and updating, may improve computer technology by preventing a Task Scheduler or job scheduler from being burdened with executing processes which perform these tasks, and may mitigate drift management. Embodiments may improve IT technology by avoiding the need for adding each maintenance task to a job or Task Scheduler, which can be costly in terms of computation and manpower. For example, to add a task to a Task Scheduler may take several minutes per machine using a remote machine, requiring interfacing using a PowerShell process. Embodiments may allow adding such tasks using a file structure and script files, Embodiments may allow for easier monitoring of such tasks on target computers, as it may be easier to determine what processes run on a computer using a file and task structure, as opposed to using a job or Task Scheduler. Embodiments may improve the functioning of target computer systems, since a Task 1 framework script or process may have zero CPU or memory footprint when it is not executing; in general a Task 1 framework process may be low impact. A Task 1 framework script may monitor CPU or memory usage, and scheduler processes may not monitor CPU or memory usage, A Task 1 framework process may gather data on process ID (PID) or instance ID information and logs, and information related to sub-tasks, such as CPU or memory usage, in order to not overburden the target computer. Prior art systems relying on Task Scheduler processes may not have such capabilities. Embodiments may generate alerts based on such collected information and events.

A Task 1 framework or main script may execute by or within a Task Scheduler, but may handle scheduling of maintenance sub-tasks. A Task 1 script may discover, find or determine sub-task files or scripts installed on the same computer as the Task 1 script executes on, and create a data structure or table of action items, each action item describing a discovered sub-task. Task 2 sub-tasks script files (e.g. Power Shell Script files) may include code or script language instructions, may be installed on a computer by being saved under relevant subdirectories, each subdirectory corresponding to an account in which the sub-task is executed. Such subdirectories may be under a main directory, e.g. /c:/program files/MRIPASS. There may be one or more subdirectories for each account, and each such subdirectory may include one or more specific Task 2 script file to be executed by that account. Each such directory may indicate a category or OS account which is to execute the Task 2 sub-script file in that subdirectory. For example, directories or folders Core, CoreNS, Custom, and CustomNS may exist, such that a Network Service account may execute all Task 2 sub-scripts stored in directories within the CoreNS and CustomNS directory, and the System account may execute script files stored underneath the Core and Custom directories. Other specific directories and accounts may be used. To install a new sub-task script on a computer a process may store the appropriate sub-task script file in the appropriate sub-directory. Deleting sub-task scripts may be performed by deleting the file corresponding to that sub-task script.

A framework script may periodically review the sub-task files in each directory as part of discovery, compare the reviewed sub-task files to the list or table maintained by the framework script of sub-tasks, and add or delete sub-tasks. New or no-longer-seen in the directories, noting which account the sub-task is to execute in based on the directory in which the sub-task is seen. The directories storing the sub-task files may be secure, such that only IT personnel or processes with appropriate permissions may save files in the directories: for example an IT professional may install a sub-task on multiple computers remote from the computer operated by the IT professional by saving an appropriately signed sub-task file in the proper directories on these remote computers: for example an IT professional operating IT computer 10 may send a sub-task file 26 to multiple user devices 20 which is saved in the proper directory on devices 20.

Sub-task scripts may be authenticated by including a digital signature which is created by a secure, known entity. In one embodiment, as part of the sub-task script creation process, the sub-task script may be sent to a central signing authority or process, which may apply an algorithm, hash, or encryption process to the sub-task script to add a signature to the script. After this, the signed script may be distributed and installed in the relevant user computers 20.

A Task 1 framework or main script may determine or discover the sub-task scripts installed (e.g. saved) on the computer executing the Task 1 script by reviewing the directory structure, and adding to a table or data structure each Task 2 sub-task found in the sub-directories. A Task 1framework or main script may correlate certain OS accounts with certain sub-scripts based on sub-directories. For example, if sub-script “backup customer database” is stored in the file and directory structure /CustomNS/backup customer database.ps1, a Task 1 script may associate the backup customer database.ps1 script with the account associated with the CustomNS directory (e.g. the Network Service account) which will be used to execute backup customer database.ps1. Each sub-task script may be stored or installed in a filesystem directory corresponding to an account in which the sub-task script is to be run. A backup script may determine the geographic region of the computer executing the script, and according to this region back up data to a specific (e.g., closest) data repository. In order to enable this, a method assigning the executing computer to a group based on the group or subgroup, may have the group corresponding to the computer have permissions to save files to this closest data repository: this permissioning may be performed without passwords.

A Task 1 framework script may create a table of Task 2 sub-tasks by reading header information from the sub-task files (e.g. . ps1 readable text files), and using this information to create a list of subtasks, and metadata re the subtasks, such as scheduling, periodicity, etc. Such a table may be for example a table in memory, e.g. a light database, including the sub-scripts to executed, and may include all scheduled jobs for the framework task. A framework script may execute sub-tasks by for example opening the file folder or directory containing the sub-task script, opening the sub-task script file, checking the file integrity (e.g. by validating a signature as discussed elsewhere herein), checking a header or other administrative information for proper values (e.g., conditions under which the scripts may safely run, such as a time or date during which the script should run, or other conditions), then scheduling the sub-task to execute using the Task 1 scheduler. A sub-task script may be executed only if its signature matches the sub-task script itself (e.g., the script minus the signature in the script). Such a table may be dynamically created each time a framework script is run, and may disappear when the framework script stops execution (e.g., daily); such a system is an improvement over technology storing administration tasks in a file, as the table is a data structure private to the framework process instance, and not easily hacked into. Each sub-task script may include administrative information (for example in a header, at the beginning of the script), which may allow customization of the script beyond the capability of a job or Task Scheduler. Such administrative information may include repetition or timing information, specifying when the sub-task should be executed (e.g. once a day at 4:00 AM and 10:00 PM), which if performed using prior art Task Scheduler technology may require multiple Task Scheduler entries. Such administrative information may allow flexible scheduling: for example a script may created in response to an immediate crisis; then script can delete itself, based on administrative information in the script. Similarly, administrative information may cause a script to be run once at certain time and/or date and then terminate and be deleted.

A Task 1 scheduler may, based on the information in the table of Task 2 sub-tasks, execute each sub-task according to its schedule: e.g. periodically (e.g. once per hour); once only; or on other schedules or conditions. A Task 1 scheduler script may call or execute a Task 2 sub-task script, according to OS and other protocols, e.g. according to the Windows OS and PowerShell system. In order for a Task 1 scheduler to call or execute a Task 2 sub-task script the scheduler script may ingest a relevant portion of a Task 2 script (e.g., as shown in the “#Process SCM Files and Start Tasks that are Ready to Run” section in Table 1D herein). A Task 1 scheduler script may execute sub-tasks in a relevant account, for example the OS account corresponding to the directory or subdirectory of the sub-script. Such an account may have the proper set of rights or permissions for the Task 2 script to execute and access resources. In one embodiment one Task 1 scheduler script may execute scripts using two separate accounts (e.g. Network Services and System), each separate account executing sub-tasks concurrently. However, within one account, sub-task scripts may execute in series to avoid loading the executing computer, but serial execution need not occur.

A Task 1 framework or main script may improve computer technology and ensure security by for example ensuring sub-tasks are signed or otherwise authenticated. In one embodiment, each sub-task script is in a file which includes (e.g. at the end) a digital signature which is created by a secure, known entity (such as a process creating the sub-task text file), and which may be, e.g., the hash of the script file. The entity creating the digital signature may use the same encryption method used by a framework script to ensure that the signature matches the subscript file. The signature may be a block which is part of the human readable file for the script. Altering the code of the script may cause the signature to no longer match the script, and break the integrity of the signature. The Task 1 or framework script may recompute this signature each time it executes the sub-script, and only execute the sub-script if the computed signature of the sub-script (e.g. the hash) matches the signature in the script itself; if the computed signature does not match the sub-script is not run. For example, a framework may hash the entire subscript file, or the portion of the subscript file omitting the hash or signature contained in the subscript file: if the framework computed hash matches the hash in the subscript file, the file is validated for execution, otherwise it is not. The use of scripts may further aid security, as virus programs typically do not easily piggyback on scripts.

Embodiments may use a process installed locally on computers in a global manner for the collection of various data items or data points, e.g., checking for known issues to automatically remediate them. Such automation may reduce the number of help desk calls and desk side visits to resolve known system issues. Prior art systems may monitor, maintain and update computers by, for example installing an intrusive application on the computer; executing resource intensive services on the computer; inundating and overloading a Windows OS built-in Task Scheduler with numerous tasks. Some prior art methods can crash a Task Scheduler with constant removal and addition of tasks. Embodiments of the present invention may, in contrast to the prior art, a task to a target computer's Task Scheduler or similar process, where that task in turn handles multiple sub-tasks. The Task 1 executed by Task Scheduler may execute sub-tasks both under a “System” account (e.g. for tasks requiring local elevation, and performing data collection and remediation tasks); and under a “Network Service” account (e.g. for tasks requiring network access). Such a second Task 1 may use Task 2 subtasks to perform maintenance tasks such as backing up data from local system to a secure network location. Embodiments of the invention may, unlike prior art methods not require a password to connect to network resources, where most applications require an account with privileged access to connect to resources. While two specific example tasks (Task 1 and Task 2) are discussed, other numbers of tasks may be used in different embodiments. While the tasks are used with a Windows Task Scheduler in some embodiments, other control or scheduling systems may be used.

Using a Network Service account or other accounts may be advantageous in that a Network Service account may have no known passwords associated to it. Therefore, the account cannot be impersonated, and passwords do not need to be administrated, kept secret, changed, etc. Using scripts executing in particular user accounts and installed under directory structures, on computers granted permissions as described herein, may obviate the need of manually managing passwords. Such permissioning may be used to enable sub-task scripts installed on computers to perform tasks such as backing up files to the nearest data center, or accessing resources.

Examples of Task 2 or subtask functions that may be carried out by scripts include defragmenting or cleaning a disk drive or hard drive (typically that of the computer executing the Task 2 script); scanning a hard or disk drive and freeing up local disk space; determining disk drive or hard drive parameters and transmitting the parameters to a remote computer; determining OS parameters (e.g. for an OS installed on the computer executing the Task 2 script) and transmitting the parameters to a remote computer; determining the health of a process such as a Citrix process and transmitting the results to a remote computer; determining network adapter parameters (e.g. for a network adapter installed on the computer executing the Task 2 script) and transmitting the parameters to a remote computer; profile maintenance; backing up a database to a remote computer, e.g. secured corresponding repositories; performing an ostscan, or repairing or gathering Outlook local config info; repair a broken performance counter; perform SysTrack fixes; repairing a broken SysTrack fixes database; restarting a service; cleaning up unused profiles; and performing a file or database backup to a remote computer or database, such as of customer relationship management (CRM) or other files. In some cases such tasks may be executed by scripts under a NetworkService OS account, without the need for a password. In some cases transferring data to, backing data up to, or accessing resources on, a computer remote from the local computer executing a script, may be effected by allowing resource access, by assigning computers to a group which has or is associated with appropriate permissions.

Sub-tasks may monitor information periodically, e.g. every 15 minutes, or in real time, by constantly monitoring information. Such information may be sent to for example a Splunk process for data gathering and consolidation. A centralized governance process, e.g. remote from the computer executing the sub-task, may review collected data and may issue alerts, e.g. to IT professionals. Sub-tasks may perform self-healing on the computer executing the sub-tasks, and be proactive, for example by checking if processes that should be executing on the computer are or are not, and if the process is not, re-starting it: for example, a sub-task may determine if a Citrix agent has not registered on the computer within a period of time, and if not, re-start it. Sub-tasks may be scheduled (e.g. via their headers) to operate during periods users are less likely to be working, e.g. at night local to the computer: for example sub-tasks may query or data gather during the day and fix problems during the night. Scripts may access local computer data according to account permissions: e.g. sub-scripts may access Windows Management Instrumentation (WMI) data to read settings or conditions and report on these settings to a central, remote database, or act on these settings or conditions. Sub-scripts may hook in to and use .net, wmi and other Windows API calls.

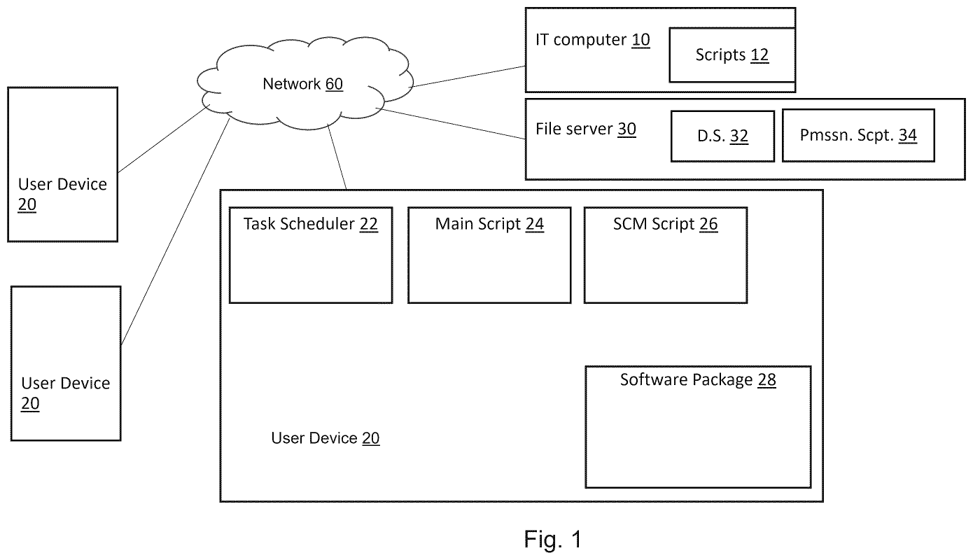

FIG. 1 depicts a system for managing computer systems according to embodiments of the invention. The system of FIG. 1 may be used for, for example, distributing and operating monitoring and maintenance processes, assigning or granting rights or permissions for a set of computers, or other tasks. An IT professional computer system 10 may be used to create, distribute, and control operating monitoring and maintenance processes to user or other computers 20 (e.g. user PCs, user laptops, virtual desktops (e.g, executed on a computer), etc.), each of which may have a name, hostname or ID. IT professional computer system 10 may assign or control permissions for a set of computers, the method comprising. While one IT professional computer system 10 is shown, more than one such computer may be used in some embodiments.

File server 30 may store files accessed by, or backed up by, computers connected to one or more networks in an organization such as devices 20, for example using a directory or entitlement service or other system 32, such as the Microsoft Active Directory directory service.

Devices 20 may be personal computers, desktop computers, laptop computers, workstations, server computers, network devices, cellular or mobile devices, etc. Computers 20 may be, e.g. used by workers as part of an organization. Only the details for one of the user computers 20 are shown, for clarity. A typical implementation may include hundreds or thousands of user computers 20, and multiple IT professional computers 10. A device 20 may back up or save a file local to device 20 to file server 30, and permission for that device 20 to access the directory on server 30 where the file is stored or backed up to may be granted using such directory or entitlement service 32.

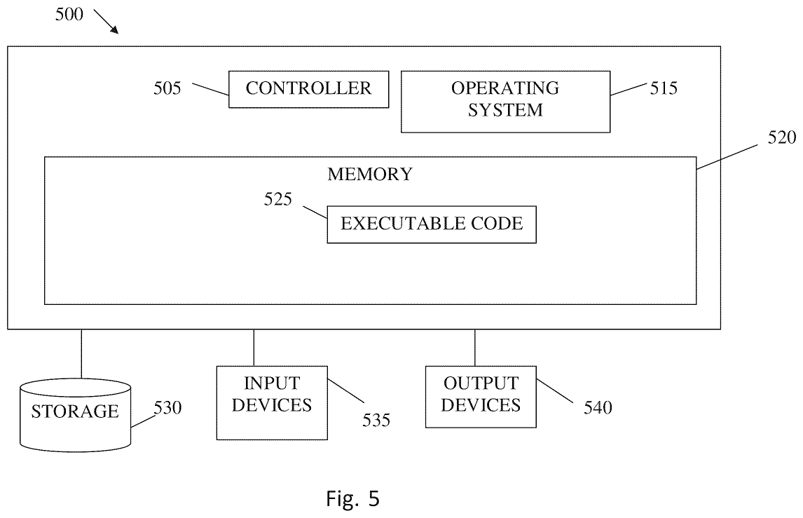

Directory or entitlement service 32 may be part of or associated with an OS 515 (FIG. 5). A permission script 34 may execute, for example in a GMSA (Group Managed Service Account, which in a Microsoft implementation has permissions to alter Active Directory information) or other account, and may periodically poll the network for computers or devices 20 which are not known to entitlement service 32, and add devices 20 to the proper permission script 34 categories or security groups.

The various functionalities and modules shown need not be performed by the specific devices shown: for example, one IT professional computer system 10 may add computers to groups for the purpose of controlling entitlement, and a separate IT professional computer system 10 may be used to enforce entitlements, e.g. the ability to access files. Directory service 32 need not be executed on file server 30, and other numbers of file servers may be used.

An IT professional computer system 10 may develop scripts 12 and distribute them to user computers 20 (e.g. saved as scripts 24 and 26). A user computer 20 may include a job or task scheduler 22 (e.g. a Windows OS built-in Task Scheduler, working within the context of an OS 515 (FIG. 5), which may be a Windows OS; however other Oss may be used) or the Linux chron jobs system, or another scheduler process), which executes periodically, e.g. every five minutes, or another period. Job or task scheduler 22 may be a computer process controlling and starting computer jobs or tasks such as those executing unattended in the background.

Job scheduler 22 may execute on a user computer 20 and may cause the execution of a main or framework script 24 (e.g. “Task 1”), which may control or cause the execution of “Task 2” sub-task or SCM scripts 26. Scripts 24 and 26 may include or be written in a scripting language (e.g. the PowerScript language). While one sub-task script 24 is shown for clarity, multiple such scripts may be used on a user computer 20. Job scheduler 22 may execute or restart framework script 24 periodically, e.g. every 5 minutes, to ensure framework script 24 executes, in case it fails to run continuously in a loop or terminates unexpectedly. In one embodiment job scheduler 22 does not execute an instance of framework script 24 if another an instance of framework script 24 is currently executing (on the same computer that is executing job scheduler 22 and framework script 24, or in the same account).

Main script 24 may terminate, exit or stop execution periodically, e.g. midnight each day or after a predetermined period of time of execution, to avoid long run times or memory bloat, and may execute in a loop to launch sub-task scripts 26. For example, main script 24 may loop with an interval (e.g. a one-minute interval) in between each run to check for updates of or to the sub-task scripts 26 to be executed on the user computer 20 executing main script 24. Main script 24 may launch a sub-task script 26 causing it to be loaded into memory, according to the scheduling of the sub-task script 26, for example appearing in its header. Main script 24 may launch sub-task scripts 26 consecutively—e.g. one at a time on a particular user computer 20—in order to avoid potentially causing high CPU usage or other burdens. Main script 24 may, for example log or record its activity.

Sub-task script 26 may perform administrative or data gathering tasks, and may include information in the script itself, e.g. in a header, telling a main script 24 the frequency or defined interval the sub-task script 26 is to be run. Sub-task script 26 may log execution or diagnostic information to local log files and event logs. Among the tasks of a sub-task script 26 may be to interact with a software package 28, e.g. an application, executing on device 20.

One or more network(s) 60, such as an intranet, the internet, a combination of networks, etc., may connect the various components, allowing the components to communicate.

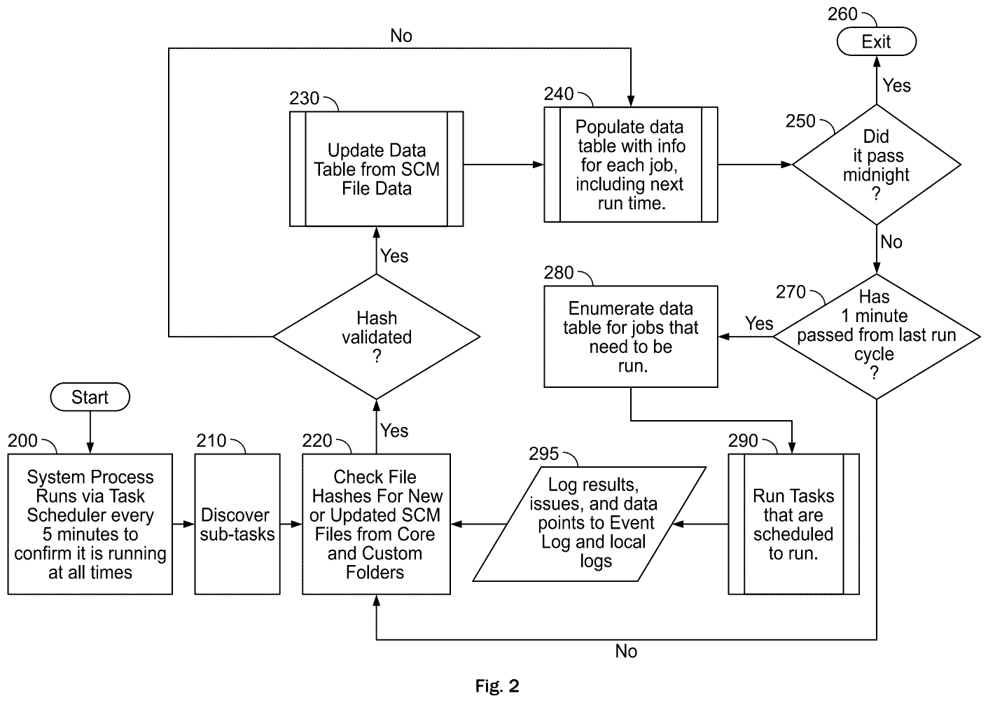

FIG. 2 depicts a flowchart of a process for controlling a computer according to some embodiments of the invention. As with other flowcharts described herein, the process of FIG. 2 may be performed with systems such as in FIGS. 1 and 5, but may be performed with other systems. As with other processes described herein, while an exemplary method is depicted for illustrative purposes in the flowchart of FIG. 2, it will be appreciated by those skilled in the art that features and operations from this procedure may be selectively combined with features and operations from alternative embodiments of the invention without departing from the remit of the disclosure. Further, while certain features and operations are expressly included in the flowchart of FIG. 2 (and other flowcharts shown herein), it will be appreciated by those skilled in the art that not all depicted features and operations are mandatory elements, and that different embodiments may omit certain features or operations without departing from the remit of the disclosure. Accordingly, embodiments including combinations of the features and operations recited in FIG. 2 and other flowcharts are expressly within the remit of the disclosure and do not constitute an intermediate generalization of the same.

In operation 200, a job scheduler or Task Scheduler process may be executed on a computer, and the job scheduler may execute a framework script written in or including a scripting language. For example, a Task 1 framework process, or “system process” may be executed by a job scheduler. In one embodiment, this is a process in a script language executed by a job, e.g. every five minutes, or another periodicity. A job scheduler may periodically check if a The Task 1 framework process is executing, and if not start such a script (if a Task 1 script is executing already, typically a second is not started). In operation 210, the Task 1 framework process or script may discover (e.g. determine which exist) the one or more sub-task scripts, e.g. Task 2 scripts, installed on the computer, each sub-task script written in the scripting language (typically, but not necessarily, the same language as that of the Task 1 script), e.g. from Core and Custom file folders. A framework may also detect if any Task 2 scripts have changed or updated, e.g. by checking the files or file dates in the relevant directory. In one embodiment Task 2 sub-task scripts are installed by being stored in a file system directory corresponding to an account in which the sub-task script is to be run. Discovery of sub-task scripts may include the framework script analyzing the relevant directory structure, and adding a sub-task each time a newly-seen sub-task file is discovered.

In operation 220, the Task 1 framework process may check signatures or file hashes for newly discovered or changed Task 2 sub-task processes to validate the sub-task script files. In operation 230, for each Task 2 file where signatures or hashes indicate the file has been changed or updated, a data table identifying for the framework process a list of sub-task processes may be updated to include the new or changed processes. For scripts where signatures or hashes are not positively validated (e.g. the signature in the file does not match a signature generated by applying a signature or hash function to the file) the file may not be added to a data table. Validation/non-validation may be logged. In operation 240, new files detected and validated may be added to the data table. In operation 250, it may determined if a certain period of time, such as a day, has passed, or if a certain time has passed; for example it may be determined if midnight local time for the target computer has passed.

The framework script may terminate or exit after a predetermined period of time, or at a fixed time: in operation 260, if the time period has passed, the process Task 1 framework process may terminate, and will typically be re-started within a short period of time by the job or Task Scheduler. In operation 270, if the time period has not passed, it may be determined if a certain period of time, e.g. one minute or another period of time, has passed from the last time the run cycle of Task 2 scripts has occurred; if yes, then in operation 280 the process Task 1 framework process may populate or enumerate a data table for sub-task jobs currently needed to run (which may be a subset of the tasks in the data table used in operations 230 and 240). If the period of time has not passed, operation may move to operation 220. In operation 290, the process Task 1 framework process may execute the discovered sub-tasks or Task 2 scripts enumerated in operation 280, for example by executing the script files corresponding to the sub-tasks. In one embodiment the framework script determines CPU usage on the computer executing the framework and sub-tasks, and executes a sub-task script only if the CPU usage is below a predetermined threshold. Sub-tasks may be executed consecutively (one executing only after the prior terminates) to avoid causing high CPU usage. Subtasks may be loaded into memory by the framework script and invoked on the schedule defined by the subtask script header. In operation 295, any results, issues or problems, or data points, may be logged or recorded to logs such as an Event Log and/or local logs, and the process may continue with operation 220, looping to check for updates and execute scripts if needed, until the framework terminates.

Other operations or series of operations may be used.

A process such as a Task Manager may confirm a Task 1 framework task is running, e.g. every 5 minutes, and may start execution of it only if it is not running already. In one embodiment, a Task 1 framework process, also termed a MRIPASS (Monitoring of Realtime Information—Proactive Automated Solution Service) may be installed on a target computer as an application, e.g., to be executed by a job or Task Scheduler. Typically, no executables or dynamic link libraries are installed, as the process is typically a script, for example based on PowerShell scripts installed for example as “MRIPASS.ps1” under a directory or folder such as “C:\Program Files\CompanyName\MRIPASS”. Scripts as described herein may be stored and organized under directories in the directory structure of the target computer, but other ways of storing and organizing files may be used. The main script may operate a Task 1 framework process (e.g. named MRIPASS.ps1) and may be saved in the root of “C:\Program Files\CompanyName\MRIPASS”. A Task 1 framework process script (e.g. MRIPASS.ps1) may execute all day and exit at a certain time, e.g. midnight; however other methods of scheduling such a process may be used. A Task 1 framework script may be relaunched by a job scheduler such as a Windows Task Scheduler periodically, e.g. every 5 minutes, unless it is determined that a framework script is already running.

The core scripts that run under the “System” account may be stored under the subfolder “C:\Program Files\CompanyName\MRIPASS\Core”. The custom scripts that run under the “System” account may be stored under the subfolder “C:\Program Files\CompanyName\MRIPASS\Custom”. The core scripts that run under the “NetworkService” account may be stored under the subfolder “C:\Program Files\CompanyName\MRIPASS\CoreNS”. The custom scripts that run under the “NetworkService” account may be stored under the subfolder “C:\Program Files\CompanyName\MRIPASS\CustomNS”.

A Task 1 framework script (e.g. MRIPASS.ps1) may read Task 2 sub-task scripts, for example stored in Core, Custom, CoreNS, and CustomNS folders. Task 2 sub-task scripts, or SCM files, may include a header or initial text including administrative information such as scheduling data, and a code section, which is the task, written in the script language, that will be performed. The framework script may split each sub-task or SCM file to, for example, read the administrative information to obtain the cadence, e.g. how often to execute the sub-task, and the script instructions, e.g. what to run during that timeframe. Each sub-task or SCM may execute in its own run space bubble, and may include a timeout in its administrative information or header, which may allow the framework to expire the process if it runs past its time limit to run. The framework process may monitor the relevant subfolders (e.g. the example four subfolders discussed elsewhere herein) for changes, additions or updates and may reload an SCM if it has been updated, remove it from the framework script's internal table or list of subtasks if it has been deleted, and add any new ones it finds. The framework may exit out if it has been updated, so the task scheduler can relaunch the new version. For example, a framework script may check its own hash against its own file listing, and if the hash does not match, it may determine it has been updated. Sub-task scripts may be signed, and if they are not they may be flagged that they are missing a valid signature, and not executed. Actions or events including failures (e.g. improper signatures) and errors may be logged or recorded to local log files, e.g., stored under C:\SysAdmin\Log\MRIPASS; such actions may be added to a Windows event log. An embodiment may use a custom event log (named, e.g., Monitoring) and a custom source (which may identify the process which is the source of the event, and which may be named, e.g., MRIPASS). Event log entries may be collected by a third-party event log collection utility, so dashboards and alerts can be created. Tools that can be used to collect events for dashboarding include the Splunk tool, but other tools may be used. Dashboards or displays may output to a user automated actions taken and provide alerts for unresolvable issues.

Log files may be maintained and backed up. For example, when a log file reaches 10 mb, if a backup log exists, the backup is deleted; and the current log file is renamed to have “.bak” extension. A new log file may be created. Log file naming may be, e.g., for MRIPASS SYSTEM Entries:
Framework—MRIPASS-SYSTEM-Main.log
Errors—MRIPASS-SYSTEM-Errors.log
High CPU—MRIPASS-SYSTEM-CPU.log
High Memory—MRIPASS-SYSTEM-MEM.log
MRIPASS NETWORKSERVICE Entries
Framework—MRIPASS-NETWORKSERVICE-Main.log
Errors—MRIPASS-NETWORKSERVICE-Errors.log
High CPU—MRIPASS-NETWORKSERVICE-CPU.log
High Memory—MRIPASS-NETWORKSERVICE-MEM.log

MRIPASS SCM entries may follow the following example format: SCM-<SYSTEM or NETWORKSERVICE>-<SCM Name>.log.

The SCM or sub-task files may have their own flexible schedules, which can be used to execute them at more beneficial times to avoid impacting users during business hours and assure machines are in an RFB state (Ready For Business). A framework process may include built in safety checks to reduce memory and CPU usage, for example by pausing the spawning of processes during high memory or CPU consumption. Thus, a Task 1 or framework script may determine CPU usage on the computer, and then may execute a sub-task script only if CPU usage is below a predetermined threshold, and may not execute, or may delay executing, the sub-task script if CPU usage is at or above the threshold.

A framework process may include safety code to prevent it from initiating subscripts which overload the executing computer.

Embodiments may improve technology for distributing and installing software for managing computers. Sub-task or SCM files may be distributed to user computers via secure methods to the relevant directories, or get pulled down from distributed shares to relevant directories. A distribution process may mirror what is on the share from, e.g., Core and CoreNS folders, and thus this method may handle both adding and removing SCM or sub-task files when no longer needed. Business specific SCM files may get pushed to the Custom and CustomNS folders. In this manner, new functionality can be distributed easily by distributing files, which are then reviewed and implemented by framework scripts, as opposed to prior art technology, requiring interaction with job or Task Scheduler processes. New Task 2 solutions can be introduced in multiple target machines as for example Core for global use, or Custom for business unit (BU) or departmental use.

Each SCM or sub-task file may be designed to take care of specific actions and write results to for example both a local log and the Windows event log. Such functionality may include for example:

Data Collection—a sub-task may gather specific data.

A sub-task may monitor, identify, or check for, problems, issues or conditions that require remediation on a target computer, and execute processes on the target computer to remediate the condition. Identifying conditions may result from a query (e.g. a sub-task determining a contention exists) or a self-heal and may propagate a solution using for example a Splunk process, or other suitable cures, and may be event driven.

Backups—a sub-task may backup local data to secured network share location.

Other functionality may be performed by sub-tasks.

Secure backups from a computer executing a sub-task to remote filesystems or network shares may be accomplished by, for example, creating groups in a directory or entitlement service such as the Active Directory service. The groups may be associated with filesystems or shares that are trusted (e.g. access granted). Example groups include:
BU1-NetworkService-Virtuals
BU1-NetworkService-Laptops
BU1-NetworkService-Workstations
BU2-NetworkService-Workstations
BU2-NetworkService-Laptops
BU2-NetworkService-Virtuals

Adding target computers to a group of computers having management or maintenance software according to embodiments of the invention may be effected by adding the computers to DFS groups. For example, groups in AD may be populated by a script on a server which runs on a cadence and adds new or missing computers to the appropriate group, so they will become trusted to the secure share, which allows the local NetworkService account to write to it.

One sub-task or SCM function may be to backup data, such as customer relationship management (CRM) databases, to a secure location, e.g. a secure remote filesystem or share. The sub-task logic may decide on the closest location to which to copy the local data. Compressed versions may be copied during non-working hours to avoid user impact.

One sub-task or SCM function may be to provide AD PC group automation. Such a process may execute on servers independently of machines executing a framework or MRIPASS according to embodiments of the invention. Computers requiring secure network backups may need such a process to ensure that the machines running a Task 1 framework process such as MRIPASS are added to the correct groups to gain access to these secure shares. A Task Scheduler process on servers may execute an AddMember.ps1 process periodically, e.g. every five hours, to add machines to their correct group. A Task Scheduler process on servers may execute an Archive.ps1 process periodically, e.g. every Sunday at 1:00 PM, to email results of group additions. Machine Group additions and weekly result emails may be accomplished using for example a GMSA (Group Managed Service Account)

Embodiments may improve computer maintenance by allowing systems to be more self maintaining for version control. For example, if a machine is offline or not connected to IT related computer systems, that machine cannot get updates, but it can execute its IT tasks locally using the framework script.

Embodiments may allow tasks to not interfere with each other, and to not increase CPU or memory usage beyond thresholds. Administrative information, e.g. in a header of a script, may include, for example a maximum runtime for the task in the script, which may limit the time the script can execute and prevent a runaway script error. Such administrative information, or other information, may allow a script to pause or stop execution if, for example, CPU or memory usage rises above a certain level.

Table 1A below shows a portion of an example script, in the PowerShell script language, for operating a framework “Task 1” script according to some embodiments. The portion of the script shown in Table 1A defines functions for a framework process.
<#
Data Table Attributes from SCM Header
Description—Description to be displayed to user for user StartedBy tasks.
RunAs—Run as User or System context.
Frequency—RunNow, RunOnce, Daily, or Time.
UOM—DayOfWeek or Day. Only used for Daily and Time.
Interval—DayOfWeek=Day Names or “All”. Day=Days of Month or “All”. Only used for Daily and Time.
Repetition-RunOnce=Specific Date and Time. Daily=Minutes in between runs. Time=Times to run. Not used for RunNow.

### Data Table Attributes Determined by Main Script

FullName—Full file name with path.
Code—The actual script code to run.
TaskType—Core or Custom.
SHA1—SHA1 of file to check for changes.
StartedBy—Task started by User or System context.
NextRunTime—The next time the task needs to run.
Status—Waiting or Running.
MaxRunTime—Maximum number of minutes this script can run.
#>
<#
.SYNOPSIS

Framework designed to schedule, monitor, execute, self-heal, log and report all automation activities
#Reset Environment

The instance is level set by all variables being removed, all modules being removed, and clearing of remnant errors.
#Define Functions
Function Write-Results—Standardizes buffering and error handling when writing to local text files.
Function Backup-Log—Maintains log sizes and keeps current and most recent copies, deleting older logs.
Function Write-Event—Standardizes writing to the Windows local event log.
Function Get-NextRunTime—Validates SCM scheduling header variables and updates scheduling data table with the schedule and script to be executed.
Function Set-ThreadCulture—Forces culture to run in a given localization which ensures the time entries are handled correctly.
Function Get-CPUByPID—Checks CPU utilization of MRIPASS process to ensure script is not causing high CPU and if CPU is running high, starting of new SCM are delayed to avoid adding increasing CPU utilization.
Function Get-TotalCPU—Checks over all CPU utilization of entire system and delays starting any new SCM instances to ensure script does not add overhead during times of high CPU.

### Table 1A

Table 1B below shows a portion of an example script, in the PowerShell script language, for operating a framework “Task 1” script according to some embodiments. The portion of the script shown in Table 1B defines example subroutines for an example framework.
Task Processing Routines
#Add Waiting Tasks to Run Space Pool—Tasks that are ready to run, based on their scheduling are added to a task pool to run.
#Change Status to Removed if SCM if no longer exists on disk.—If SCM file no longer exists, then it is removed from the table.
#Run Code to Complete Task—If scheduling requirements are met, SCM is started.
#Mark task as Completed for Run Now and Run Once Entries—One time SCM are marked removed upon completion.
#Get Next Run Date—Function is called to schedule next run time to be updated in scheduling data table.
#Data Table Updating Routine
#Update Data Table Subroutine Start
#Check for Engine Updates—Checks are performed to check for any SCM changes.
#Enumerate and Load SCM Files—SCM are inventoried on disk and updates are performed as required, including removing deleted SCM, adding new SCM, and updating SCM.
#Split into Header, Code, and Ignore Signature—Breaks up SCM into required components.
#Invoke the Header to Set Variables—Extracts scheduling variables.
#Check If Entry is already in Data Table—Verify SCM does not already exist.
#If the SHA1 changed and the Task Status is Waiting, then Mark as replaced.—Flag updated SCM as needed.
#Get Next Run Time Date and Validate—Call Get-NextRunTime function to update schedule in data table.
#Check If NextRunTime variable is Valid—Validates scheduling variables in SCM.
#Log NextRunTime Calculation Failure—Log any scheduling errors.
#Set Status to Bad Date—Flag SCM with bad schedules, so they can be ignored until updated.
#Reset NextRunTime—Reset the next run time schedule
#Validate Script MaxRunTime—Validate the variable the indicates the maximum time the script can run.
#Log MaxRunTime Calculation Failure—Log maximum run time variable failures.
#Set Status to Bad MaxRunTime—Update the data table to flag it with a bad maximum run time variable.
#Verify that Scripts are signed and do not add them if they are not.—Validate scripts are properly signed.
#Set Status to Bad Cert—Flag SCM in data table with a bad certificate signature.
#Populate Data Table—Add validated SCM to data table.
#Add with Template—Add SCM template to data table.
#Set the Values—Update template with SCM values.
#End Sub Update Table
#Log Pending Messages Routine
#Pending Message Processing—Buffer pending log message entries.
} #End Sub Log Pending Messages
#Perform Exit—Exit routine process.
#Perform Exit Routine—Performs exit routine, which includes clean up of workspaces, variables, and hygiene routines.
#Exits at Midnight and Windows Task Scheduler should re-launch this script.—Nightly exit routine occurs every night at 11:59 PM to ensure healthy running in clean state.

1#Log Pending Messages—Log any pending buffered messages.
} #End Sub Perform Exit

### Table 1B

Table 1C below shows a portion of an example script, in the PowerShell script language, for operating a framework “Task 1” script according to some embodiments. The portion of the script shown in Table 1C provides example script variable definitions for an example framework.
###Script Start ###—Main portion of script start.
#Force the current thread's culture to ‘en-US’ for session to correct for time comparison issues.—Adjusts time zone localization.
   #Define Main Script Variables—Initializes main script variables.
   #Initialize Time Tracking Variables—Initializes time tracking variables.
   #Check if script is already running and exit.—Prevent running more than one instance of script per user context.
      #Exit if another instance is already running in the same context.
   #Create Scheduling Hash Table Template—Define scheduling template.
   #Create Scheduling Hash Table List—Create list to hold schedules.
   #Add Event Log Source If Not Exist—Add event source if it does not exist.
   #Create Log Directory—Create folder to hold logging files if it does not exist.
   #Script-Started Confirmation—Log script start.
   #Create InitialSessionState—Initialize session state data.
   #Create Session State—Create session state data.
   #Add Synchronized Shared Variables—Create variables to be used across sessions.
   #Getting the function definition for the function to add.—Create shared function objects to be shared across sessions.
   #Create Runspace Pool Consisting of Max Threads, Modules, and Environment-Initialize workspace pools.
   #Create Runspace Pool Array List-Create workspace pools.

### Table 1C

Table 1D below shows a portion of an example script, in the PowerShell script language, for operating a framework “Task 1” script according to some embodiments. The portion of the script shown in Table 1D provides an example processing loop for an example framework.
#Create loop to run tasks as required.—Create workspace loop.
   #Run Update Data Table Subroutine—Executes Update Data Table Routine.
   #Process SCM Files and Start Tasks that are Ready to Run—Enumerate SCM and start the ones that are ready to run.
   #Manage Runspace Tasks—Process workspaces.
      #Remove Completed Tasks—Remove completed SCM.
      #Remove Tasks Exceeding MaxRunTime—Remove SCM that ran pas their maximum run time allotted from header.
   #Add Running Job Count to Log—Log running jobs.
   #Log Expired Tasks—Write expired SCM list to logs.
   #Backup Logs Greater than 10 MB if no jobs are Running.—Create backup of log files exceeding 10 MB and create new one. If a backup file exists, then it will be purged before it log is renamed to back up.
   #Log Pending Messages—Process pending buffered log entries and write them to log file.
   #Dump Data Table If Flag File Exists—If debugging flag exists, then dump to scheduling data table to file.
   #High CPU Threshold Handler—If high CPU usage is detected, then log and delay the start of new SCM.
   #High Memory Threshold Handler—If high memory usage is detected, then log and delay the start of new SCM.
   #Capture Errors To Log—Write unhandled errors to logging process.
   #Add Pause in Between Each Loop Cycle—Add loop cycle delay to prevent CPU thrashing.
   #Perform Garbage Collection Routines—Free up memory that is no longer in use.
   #Perform Exit Subroutines—Perform standardized exit routine.
#SIG #Begin signature block starts a signature block; the signature block itself is omitted from this example code for brevity.

### Table 1D

Table 2 below shows an example script, in the PowerShell script language, for backing up databases from the computer executing the script to a remote computer, using the executing computer's NetworkServices account according to some embodiments. The text above the “#--- \hat{ }-Header-\hat{ }---v-Code-v---#” line is an example header, describing information such how frequently to execute (typically within a unit of time, such as a day); what day of week to execute; the maximum time the script is allowed to execute before it is stopped; and other information. # SIG # Begin signature block starts an example abbreviated signature block: in a typical information the signature block is much longer.
#Data Table Attributes from SCM Header
Description—Description to be displayed to user for user StartedBy tasks.
RunAs—Run as User or System context.
Frequency—RunNow, RunOnce, Daily, or Time.
UOM—DayOfWeek or Day. Only used for Daily and Time.
Interval—DayOfWeek=Day Names or “All”. Day=Days of Month or “All”. Only used for Daily and Time.
Repetition—RunOnce=Specific Date and Time. Daily=Minutes in between runs. Time=Times to run. Not used for RunNow.
MaxRunTime—Maximum number of minutes script can run before timing out and stopped from running in session.
#---\hat{ }-Header-\hat{ }---v-Code-v---#
#Script Start
#Define script specific variable
#Define log file
#Perform script specific tasks.
#Create Status and Results.
#Use shared functions to log results.
#Exit SCM
#SIG #Begin signature block

#SIG #End signature block

### Table 2

An embodiment may poll for, receive or input computer identification or names, e.g., hostnames, and for each computer, based on the OA in which the computer is found (and possibly a sub-OA or subtree within the OA), categorize or assign the computer to a security or permissioning group. A process such as executed by IT computer 30 (FIG. 1) may assign computers to appropriate security or other permissioning groups based on the group such as OU the computer is assigned to. An OU is a container in the Active Directory domain that can contain different objects such as computers.

This automatic onboarding and assignment to security groups may eliminate the need for administrators to perform this manually. In one embodiment, the group may be a an Active Directory security group; however the group to which the machine is assigned may be a different type of group associated with or determining permissions. For example, an embodiment may divide a number of user computers into organizational units such as “Global” and “Customer management”, and each of these organizational units may be further divided into sub-OU labelled based on the type of hardware for the computers in the sub-OU, e.g. Global/Laptop/; Global/Virtual/; Global/Workstation/; Customer management/Laptop/; Customer management/Virtual/; Customer management/Workstation/. Each computer in these six example OUs (or sub-OUS) security groups may be automatically, e.g. using a script, assigned to a security group associated with permissions such that the computers assigned to a security group have those permissions enforced for each computer in the group. Associated permissions may allow the computers in the security group to access certain specific resources, e.g. file systems. A “global” group may apply to all devices on a network, as opposed to specific, e.g. organizationally defined, groups. In one embodiment, each sub-OU, or each OU/hardware category, may be mapped one-to-one to a security or permission group, such that all computers from a certain sub-OU (e.g. Global/Workstation) are assigned to a certain security group.

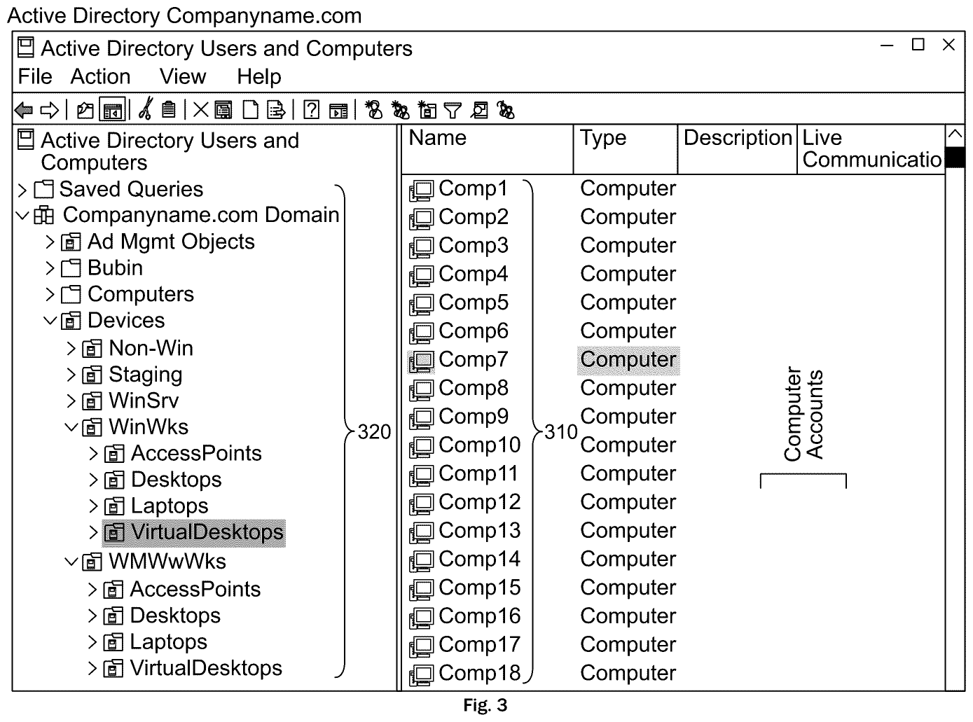

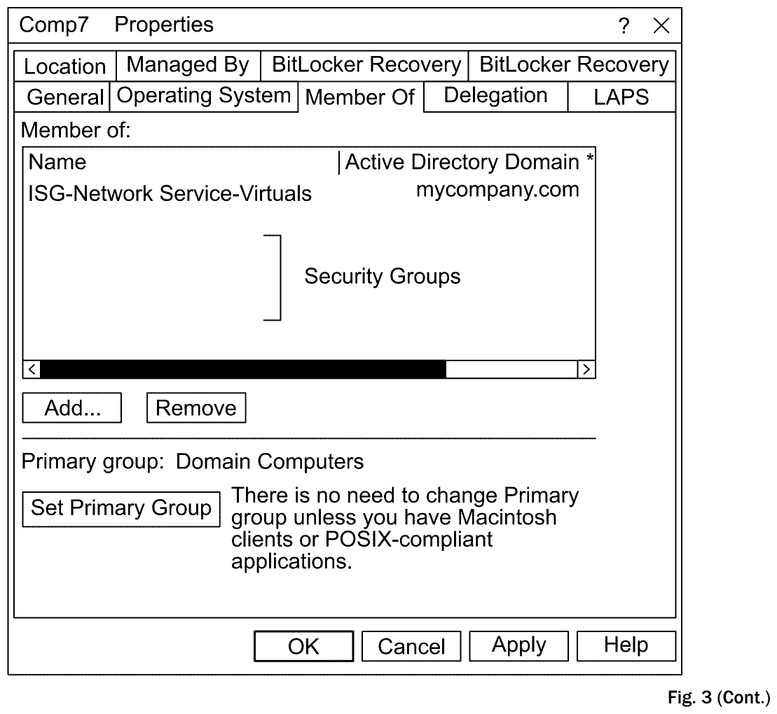

FIG. 3 depicts the organization of a set of computers each associated with a computer name, ID or hostname 310, and their relationship to Active Directory organizational units 320, according to some embodiments. Active Directory organizational units 320 may in one embodiment be divided by organizational unit, and beneath each organizational unit, hardware type, e.g. AccessPoints, Desktops, etc. Within each hardware type category may be a set of individual computers.

A name, identification or hostname 310 (which in some early systems may be termed nodename) may be a label assigned to a device connected to a computer network and that is used to identify the device. Hostnames may be simple names including a single word or phrase, or they may be structured. During the build or setup for a computer, a hostname may be assigned, and this hostname may include codes or information describing the group, including hardware type and organizational unit.

Embodiments may use security groups providing entitlement to the local secured accounts on a computer, based on the name of the computer. This may be categories based on the computer hardware type (e.g., laptop, desktop, server, workstation, mobile device, etc.) which in one embodiment provides least privileged access; or global groups which may hold all hardware types representing all devices on the network or in the organization and may provide access to various resources to perform backups of local databases, or other valuable file types to secured repositories. Determining or polling for entitlements to security groups may be based on hardware types and may be scheduled periodically, e.g. throughout the working day, to assure that all devices are accounted for and ready to execute automated tasks immediately. A weekly report may be sent, for example in a form of a spreadsheet through email, to provide the status of the automated entitlements to assure every computer device is accounted for in a permissioning system such as Microsoft Active Directory. A report may include devices which failed to be added to the onboarding process.

Embodiments may improve computer maintenance technology by removing the need for human input to administer, maintain, or required to conceal, passwords. Embodiments may allow administrators to avoid having to manually add newly discovered computer devices to security groups.

Permissions assigned to or determined for machines by their being in security or permissioning groups may entitle a computer to file system resources, e.g. backing up files to a directory or filesystem remote from the computer. While groups, permissions and resource assignments are described herein in the context of the Microsoft Active Directory system, other directory or entitlement systems may be used. Further, entitlements may be given to resources other than file system resources.

A group to which a computer is assigned may be a group within or corresponding to a directory or entitlement service group, such as an active directory security group, such as provided for in Microsoft Windows. Security groups in Active Directory may have rights or permissions assigned, for example to determine what members of that group (e.g. computers) can do, or what resources the member can access or use. For example, a computer may be given permission to back up and restore files and directories. Computers assigned to a group typically inherit the permissions and rights of the group. Permissions granted to computers may determine which computer can access the resource and the level of access, such as Full control or Read. Some permissions that are set on domain objects are automatically assigned to allow various levels of access to default security groups like an Account Operators group or a Domain Admins group.

An IT professional may assign a computer to an OU, and also may assign specific permissions to security groups. The security groups, or other units to which computers are assigned, may have permissions or rights assigned using the functionality of the directory or entitlement system. For example, a security group may have been pre-set up with certain read, write or file share permissions so that when a computer is assigned to the security group, it inherits these permissions, and can save files accordingly.

The Microsoft Active Directory system has two forms of common security principals: user accounts and computer accounts. These accounts represent a physical entity that is either a person or a computer. A user account also can be used as a dedicated service account for some applications. Security groups are a way to collect user accounts, computer accounts, and other groups into manageable units.

Such a system may not require passwords to be used in order for computers added to a network or organization to access resources such as files: the mere fact of the identification or name of the computer, assigned during the setup of the computer, may enable it to, for example, use file resources according to security group or other group permissions. Such a system improves computer management technology and may allow for easier administration: permissions may be assigned once to a group instead of multiple times to each individual computer.

A server such as an IT computer 30 (FIG. 1) may receive identifications of or hostnames for all computers on a relevant network. In one embodiment, IT computer 30, executing an Active Directory service process (e.g. directory or entitlement service or other system 32) may receive identifications or hostnames as an inherent part of the corresponding machines being added to the Active Directory domain, e.g. by an IT professional. A process such as permission script 34 (e.g. a process written in a scripting language such as the PowerScript language) may periodically, e.g. four times a day, discover new machines added to a directory or entitlement service domain since the last discovery. For each newly added machine, the permission script 34 may, based on the directory or entitlement service or other system 32 group to which the machine is added (e.g. an Active Directory OU), add the machine to the appropriate or corresponding hardware aligned security group (e.g. an Active Directory security group). Which specific security group to add a machine to may be based on the OU and sub-OU or sub-folder within an OA in which that machine is placed.

The addition of a machine to a security group may be based on machine type: for example a script may after discovering a new machine in an Active Directory OA add the machine to a security group based on machine type (e.g. laptop, desktop, workstation, virtual machine etc.). The machine type may be indicated by OU or sub-OU, or another method. In one embodiment the script uses lists and/or rules to determine, based on an input of an OU or other entitlement service group. For example, the script may for each machine discovered, determine the OU or sub-OU, and based on the OU or sub-OA, and based on the code in the script which correlates that OU or sub-OA to a security group, determine if the machine is in the correct security group.

For each computer, if it is in the appropriate (e.g. based on the OU) security or permissioning group, the server may take no action. If the computer is not in the appropriate group, the server may populate or add the computer to the relevant group, typically based on the OU or sub-OU in which that computer has been placed. The process of receiving, or searching or polling for, computer names or identifications, and adding them to groups in a security group or entitlement group, may be performed by a script, for example executing on IT computer 30, but may be performed by a process using another programming language.

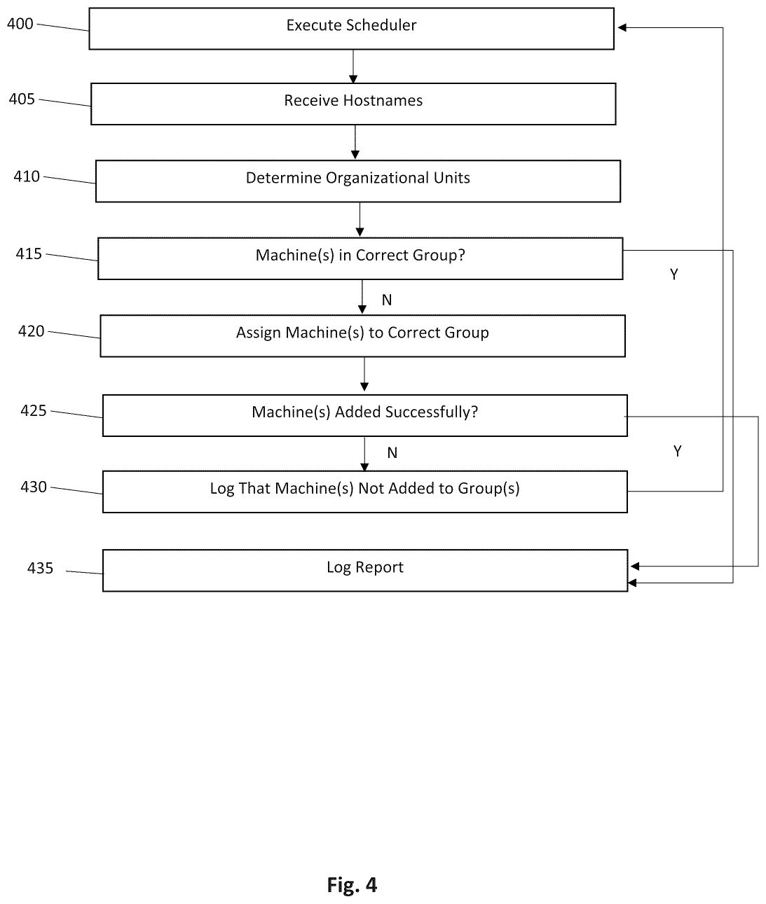

FIG. 4 depicts a flowchart of a process for assigning permissions for a set of computers according to some embodiments of the invention. In operation 400, a scheduler such as a Task Scheduler may execute on a computer such as computer 30, FIG. 1, and may start a script (e.g. written in a scripting language, such as permission script 34, FIG. 1) to add computers to a permissioning group. While a script is described as performing operations in FIG. 4, in other embodiments, programming constructs other than scripts may be used. In operation 405, the script may, for each of a set of computers, receive a hostname for the computer: by doing so the script may inventory and/or query computers. In operation 410, for each hostname received, e.g. for each computer or machine found, a process such as permission script 34 may determine the organizational unit and sub-organizational unit of the computer. In operation 415, the script may determine if the machine is part of the correct group. The correct group for a computer may be based on the OU, sub-OU, or part of an OU hierarchy in which the computer is found. For example, the sub-OU may correspond to a hardware type for the computers in that sub-OU, and each OU/sub-OU combination may be a unique group that corresponds to one security group, such that all computers in the OU/sub-OU combination belong in that particular security group.

If all polled machines are in the correct group, the process may move to operation 435, where a report may be logged or saved. If not, in operation 420, the script may assign each computer of the set of computers to a group, based on the OU, sub-OU, or part of an OU hierarchy in which the computer is found. For example, for each computer not found in the correct group, the computer may be added to the proper group, e.g. based on the OU or sub-OU of the machine. In operation 425, it is determined if the machines or computers were added successfully. If any were not, in operation 430, it may be logged or recorded that certain machines could not be added to groups, and the process may move to operation 400. If it is determined if the machines or computers were added successfully, the process may move to operation 435, where it is logged or recorded that the machines analyzed are in the correct groups.

For each computer or machine found, the group it is assigned to may be associated with permissions enforced for each computer in that group. For example, the permissions may entitle a computer to IT resources such as file system resources, such as saving or backup to a filesystem remote from the found computer. Other IT resources may be associated with granted permissions. The group may be an active directory security group, or another type of permissioning regime. The group may correspond to a hardware group (e.g. describing a type of computer, such as laptop, desktop, etc.), where each hardware group is a member of an organizational unit.

Other or different operations may be used.

Reference is made to FIG. 5, showing a high-level block diagram of an exemplary computing device according to some embodiments of the present invention. Computing device 500 may include a controller 505 that may be, for example, a central processing unit (CPU) or any other suitable multi-purpose or specific processor(s) or controller(s), a chip or any suitable computing device, an operating system 515, a memory 520, executable code 525, a storage system 530, input devices 535 and output devices 540. Controller 505 (or one or more controllers or processors, possibly across multiple units or devices) may be configured to carry out methods described herein, and/or to execute or act as the various modules, units, etc., for example when executing code 525. More than one computing device 500 may be included in, and one or more computing devices 500 may be, or act as the components of, a system according to embodiments of the invention. Various components, computers, and modules of FIG. 1 may be or include devices such as computing device 500, and one or more devices such as computing device 500 may carry out functions described herein. Components in FIG. 1, such as IT computer 10, file server 30, user devices 20, software package 28, and various scripts and other modules and processes, may be or may be executed by a computer system such as in FIG. 5.

Operating system 515 may be or may include any code segment configured to perform tasks involving coordination, scheduling, controlling or otherwise managing operation of computing device 500.

Memory 520 may be or may include, for example, one or more of a Random Access Memory (RAM), a read only memory (ROM), a volatile memory, a non-volatile memory, a cache memory, or other suitable memory or storage units. Memory 520 may be a computer or processor non-transitory readable medium, or a computer non-transitory storage medium, e.g., a RAM.

Executable code 525 may be any suitable code, e.g., an application, a program, a process, task or script. Executable code 525 may be executed by controller 505 possibly under control of operating system 515. Executable code 525 may configure controller 505 to perform methods as discussed herein. A system according to some embodiments of the invention may include multiple code segments 525 loaded into memory 520 to cause controller 505, when executing code 525, to carry out methods described herein.

Storage system 530 may be or may include, for example, a hard disk drive, a CD-Recordable (CD-R) drive, a universal serial bus (USB) device or other suitable storage unit. Data may be stored in storage system 530 and may be loaded from storage system 530 into memory 520.

One or more input device(s) 535 may be or include a mouse, a keyboard, a microphone, a touch screen or pad or any suitable input device. One or more output device(s) 540 may include displays or monitors, speakers and/or any other suitable output devices. For example, a wired or wireless network interface card (NIC), a printer, a universal serial bus (USB) device or external hard drive may be included in input devices 535 and/or output devices 540.

Device 500 may include or may be, for example, a personal computer, a desktop computer, a laptop computer, a workstation, a server computer, a network device, cellular or mobile device, or any other suitable computing device.

Unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of an embodiment as described. In addition, the word “or” is considered to be the inclusive “or” rather than the exclusive or, and indicates at least one of, or any combination of items it conjoins.

Descriptions of embodiments of the invention in the present application are provided by way of example and are not intended to limit the scope of the invention. The described embodiments comprise different features, not all of which are required in all embodiments. Embodiments comprising different combinations of features noted in the described embodiments, will occur to a person having ordinary skill in the art. Some elements described with respect to one embodiment may be combined with features or elements described with respect to other embodiments. The scope of the invention is limited only by the claims.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1. A method for controlling a computer comprising:
executing by a job scheduler process on a computer a framework script, the framework script written in a scripting language;
discovering by the framework script one or more sub-task scripts installed on the computer, each sub-task script written in the scripting language; and
executing, by the framework script, each discovered sub-task script.

2. The method of claim 1, wherein each sub-task script is stored in a directory corresponding to an account in which the sub-task script is to be run.

3. The method of claim 1, wherein the framework script terminates after a predetermined period of time.

4. The method of claim 1, wherein the framework script determines CPU usage on the computer, and executes a sub-task script only if the CPU usage is below a predetermined threshold.

5. The method of claim 1, wherein a sub-task script performs a task selected from the group consisting of: defragmenting a disk drive; determining disk drive parameters and transmitting the disk drive parameters to a remote computer;
determining OS parameters and transmitting the OS parameters to a remote computer; determining network adapter parameters and transmitting the network adapter parameters to a remote computer; profile maintenance; and backing up a databased to a remote computer.

6. The method of claim 1, wherein the framework script executes a sub-task script only if a signature in the sub-task script matches the sub-task script.

7. The method of claim 1, comprising the framework script creating a table of discovered sub-task scripts.

8. A method for performing tasks on a computer comprising:
executing by a task scheduler process on a computer a first script, the first script including scripting language code;
finding by the first script one or more sub-tasks files installed on the computer; and
executing, by the first script, code in each discovered sub-task file.

9. The method of claim 8, wherein each sub-task file is stored in a directory corresponding to an account in which the sub-task first is to be run.

10. The method of claim 8, wherein the first script terminates after a predetermined period of time.

11. The method of claim 8, wherein the first script determines CPU usage on the computer, and executes a sub-task file only if the CPU usage is below a predetermined threshold.

12. The method of claim 8, wherein a sub-task file performs a task selected from the group consisting of: defragmenting a disk drive; determining disk drive parameters and transmitting the disk drive parameters to a remote computer;
determining OS parameters and transmitting the OS parameters to a remote computer; determining network adapter parameters and transmitting the network adapter parameters to a remote computer; profile maintenance; and backing up a databased to a remote computer.

13. The method of claim 8, wherein the framework script executes a sub-task script only if a signature in the sub-task script matches the sub-task script.

14. A system for controlling a computer comprising:
a memory and;
a processor comprised within the computer, the processor configured to:
execute by a job scheduler process on the computer a framework script, the framework script written in a scripting language;
discover by the framework script one or more sub-task scripts installed on the computer, each sub-task script written in the scripting language; and
execute, by the framework script, each discovered sub-task script.

15. The system of claim 14, wherein each sub-task script is stored in a directory corresponding to an account in which the sub-task script is to be run.

16. The system of claim 14, wherein the framework script terminates after a predetermined period of time.

17. The system of claim 14, wherein the framework script determines CPU usage on the computer, and executes a sub-task script only if the CPU usage is below a predetermined threshold.

18. The system of claim 14, wherein a sub-task script performs a task selected from the group consisting of: defragmenting a disk drive; determining disk drive parameters and transmitting the disk drive parameters to a remote computer;
determining OS parameters and transmitting the OS parameters to a remote computer; determining network adapter parameters and transmitting the network adapter parameters to a remote computer; profile maintenance; and backing up a databased to a remote computer.

19. The system of claim 14, wherein the framework script executes a sub-task script only if a signature in the sub-task script matches the sub-task script.

20. The system of claim 14, wherein the framework script is to create a table of discovered sub-task scripts.
